(19) United States
(12) Patent Application Publication
(10) Pub. No.: US 2008/0301473 A1
(43) Pub. Date: Dec. 4, 2008

(54) METHOD AND SYSTEM FOR HYPERVISOR BASED POWER MANAGEMENT

(75) Inventors: Ronald Perez, Mount Kisco, NY (US); Freeman L. Rawson, III, Austin, TX (US); Leendert van Doorn, Austin, TX (US); Xiaolan Zhang, Elmsford, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/754,585

(22) Filed: May 29, 2007

(51) Int. Cl. G06F 1/00

(52) U.S. Cl. 713/300

(57) ABSTRACT

A method of hypervisor based power management, includes: allocating resources to a plurality of partitions defined within a virtual machine environment; monitoring performance of the plurality of partitions with respect to a service level agreement (SLA); tracking power consumption in the plurality of partitions; scaling power consumption rates of the plurality of partitions based on the allocated resources, wherein the power consumption rate of physical resources is scaled by adjusting resource allocations to each partition; identifying partitions that are sources of excessive power consumption based on the SLA; and adjusting the allocation of resources based on the power consumption of the plurality of partitions, the performance of the plurality of partitions, and the SLA.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to power management, and more particularly to a method and system for hypervisor-based power management in virtualized environments.

2. Description of the Related Art

Data communication continues to increase, especially with regard to the Internet where not only voice data but also high bandwidth video is being transmitted. The increasing data rates and volumes of information transmitted in communication systems and computer networks are driving demand for faster and more compact computer servers. The increased data rates require faster central processor units (CPUs) that operate at higher clock speeds. However, the higher clock speeds and data rate throughput of the CPUs create the problem of increased power consumption and production of heat. The acceleration of server consolidation in data centers has acerbated the problem. Server consolidation allows for more servers to be placed on a rack in a data center, but server racks are running close to their theoretical limit due to the need to deliver large amounts of power into a small volume, and the large amount of heat created by the power consumption. The vast amounts of heat generated in a data center having several server racks requires device thermal control and environmental cooling, which is an additional energy consumption concern. Thus, intelligent power management, at either the hardware layer or the software layer, is required to make more efficient use of energy resources. Intelligent power management allows more servers to be inserted into a rack, thus reducing space/management overhead. In addition, as energy costs keep rising, savings on utility bills become more important.

Power management has traditionally been the realm of battery-constrained devices such as a laptop, and is traditionally done at the operating system (OS) level. However, for a data center environment, an OS-only approach for managing power is inadequate for the following reasons. Traditional OS-based approaches typically optimize for a single application or a single standalone machine. Data centers, on the other hand, driven by the force of server consolidation, employ virtualization technologies to increase manageability and resource sharing.

In a virtualized environment, a layer of software called the hypervisor runs between the bare hardware and the OS, and provides the appearance or illusion of multiple “virtual” machines (VM), also called partitions or domains. A virtual machine is a virtual data-processing system that appears to be at the exclusive disposal of a particular user, but whose functions are accomplished by sharing the resources of a physical data-processing system. The VM provides a functional simulation of a computer and its associated devices and is based on an abstract specification for a computing device that can be implemented in different ways in software and hardware.

In the rack mount environment of a data center, hypervisors are employed to increase manageability and resource sharing (server consolidation). A data center typically needs to satisfy the requirements from multiple applications and/or multiple workloads each spanning multiple VM instances. In such an environment, an OS can only control the VM instance that is assigned to it and thus has only partial view of the physical system. Moreover, as a result of the sharing of physical resources, giving direct control over the power management settings to an OS running in a VM can affect the performance and behavior of other VMs, violating the isolation guarantees that are the basis for server consolidation and virtualization. A local or incomplete view of the entire system, and the need for the hypervisor to retain direct control over the physical resources of the system restrict the OS in its power management capability, and leads to sub-optimal management decisions. In addition, precise accounting for power at the OS layer is difficult, because the interface between the applications and the OS is complex, and the OS itself is a complicated piece of software, which could also consume a large amount of power and thus perturb the accounting results. For example, interleaving system calls by the OS make it hard to tell on behalf of whom the work is done and billed to. As a result, it is difficult to perform precise accounting of power usage in the OS layer.

### SUMMARY OF THE INVENTION

Embodiments of the present invention include a method and system for implementing hypervisor-based power management in virtualized environments wherein the method includes: allocating resources to a plurality of partitions defined within a virtual machine environment; monitoring performance of the plurality of partitions with respect to a service level agreement (SLA); tracking power consumption in the plurality of partitions; scaling power consumption rates of the plurality of partitions based on the allocated resources, wherein the power consumption rate of physical resources is scaled by adjusting resource allocations to each partition; identifying partitions that are sources of excessive power consumption based on the SLA; and adjusting the allocation of resources based on the power consumption of the plurality of partitions, the performance of the plurality of partitions, and the SLA.

A system for implementing hypervisor-based power management in virtualized environments, the system includes: a first layer of hardware resources; a second layer including a hypervisor that virtualizes the hardware resources and provides an upper third layer with the appearance of multiple independent virtual machine partitions; a performance monitor in communication with the hypervisor, the performance monitor configured to observe the performance of the virtual machine partitions; a policy manager in communication with the hypervisor, the policy manager configured to allocate resources to the virtual machine partitions; a power metering component and a power control component configured within the hypervisor, the power metering component configured to track power consumption in the virtual machine partitions, and the power control component configured to scale power consumption rates of the virtual machine partitions based on the allocated resources; an I/O service partition in communication with the hypervisor; wherein the power metering component identifies virtual machine partitions that are sources of excessive power consumption based on a service level agreement (SLA); wherein the performance monitor compares the performance of the virtual machine partitions to the SLA; wherein the policy manager allocates resources based on the SLA; wherein the hypervisor adjusts input/output share of the virtual machines with the I/O service partition; and kernels configured to act as session-layer functional units that support basic session services for applications requesting usage of the virtual machines.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for hypervisor-based power management in virtualized environments.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram of an existing virtualized computing system.

FIG. 2 is a schematic of a hypervisor-based power management system in accordance with an embodiment of the invention.

FIG. 3 is a flow diagram of the operation of a performance monitor component according to an embodiment of the invention.

The detailed description explains the preferred embodiments of the invention, together with advantages and features, by way of example with reference to the drawings.

### DETAILED DESCRIPTION

Embodiments of the invention provide a means for hypervisor-based power management in virtualized environments such as data centers. Hypervisor-based power management views power as another virtual resource, just like a CPU and memory. Managing power at the hypervisor layer provides three advantages. First, the interface between the OS and the hypervisor is much simpler than that between applications and the OS. This allows precise power accounting to be feasible. In addition, the componentized architecture of the hypervisor allows power consumption accounting and management to be delegated to individual subsystems such as virtual block device servers, and virtual LAN servers. Secondly, hypervisor-based power management makes it easier to standardize the power management interface across multiple OS. A standard application programming interface (API) allows the management interface to be greatly reduced, thus facilitating automatic decision making. Third, putting power management into the hypervisor or a control or service partition allows it to control the behavior of the system in such a way as to ensure both performance and execution isolation of the VMs running on top of it.

FIG. 1 is a schematic of an existing virtualized computing system 100, including hardware 102, which is a collection of resources including CPU, memory and I/O devices that are being virtualized; a hypervisor 104 that virtualizes the hardware resources, and provides the upper layer with the appearance or illusion of multiple independent “virtual” machines; kernels 106 that run inside each “virtual” machine, and applications 108 that in turn run on top of the kernels 106. The kernels are either unchanged or largely unchanged from those which run directly on the hardware, and the applications are completely oblivious of the virtualization.

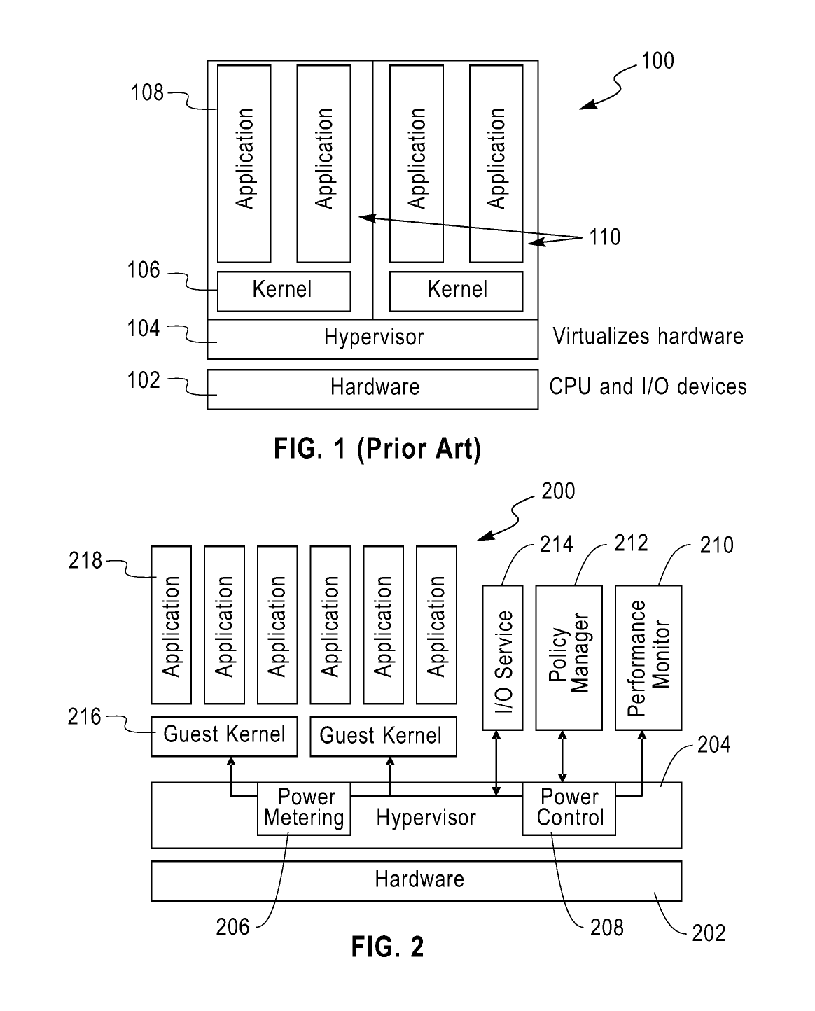

A hypervisor based power management system 200 is shown in FIG. 2, according to an embodiment of the invention. The power management system 200 includes two additional components inside the hypervisor 204 above the hardware 202, a power metering component 206 and a power control component 208. In addition, two modules exist external to the hypervisor 204, a performance monitor 210 and a policy manager 212.

The power metering component 206 keeps track of power consumption for each partition. The partitions 110 of FIG. 1 are the entities whose power consumption the metering component tracks. The power metering component identifies partitions that are sources of excessive power consumption. There are generally two ways of power metering: direct measurement and extrapolation.

In the direct measurement approach, power consumption is directly obtained from hardware (such as, for example, the service processor for the IBM pSeries, or the IBM AME for system X and Blade Server). Depending on the hardware capabilities, the hypervisor 204 may use the power readings to directly charge the energy to each partition. If the power measurement hardware does not have that capability or accuracy level, the hypervisor 204 may alternatively periodically retrieve the energy consumption readings and estimate the energy consumption per partition based on their percentage of CPU usages.

With the extrapolation approach, power is inferred only from performance data. In such a case, a separate performance monitoring subcomponent (not shown) that tracks per partition performance (and whose main purpose is to infer power consumption) is optionally included in the power controlling component 208. The power/performance relationship can also be extrapolated or learned from calibration and the use of external power measurements previously determined during a calibration period. This performance monitoring subcomponent is to be differentiated from the external performance monitoring component 210, which tracks performance at the workload level that can span multiple partitions.

The performance monitor 210 continuously monitors the performance of the involved components based on the service level agreement (SLA) (not shown) to make sure that the SLA is not violated. The SLA specifies the expectations for the level of service with respect to availability, performance, and other measurable objectives. The SLA specifies potential tradeoffs using rules and utility functions. The tradeoff is between power consumption and performance. In addition, the performance monitor 210 builds a predictive model of performance as a function of power consumption by observing the power and performance relationship over time. It is noted that the performance monitoring takes into account the division of the physical machine by the hypervisor into partitions.

The policy manager 212 collects the information and makes intelligent decisions on resource allocation, based on a prediction model for power consumption at a given performance level, and the Service Level Agreement (SLA). The policy manager 212 adjusts resource allocations to each partition, while still meeting the applications minimum performance requirements specified in the SLA.

The power-control component 208 receives decisions from the policy manager 212 and scales the power consumption rate of physical resources accordingly by adjusting resource allocations to each partition. There are multiple methods for resource allocation adjustment. For example, the hypervisor 204 may adjust the processor speed and/or share of the processor. In addition, the hypervisor 204 may adjust a partition's input/output (1/0) share by throttling the I/O usage at the hypervisor 204 or at the 1/0 service partition 214 or by changing the power configuration of the 1/0 subsystem (not shown).

The I/O service partition 214 provides at least two power-related functions. The 1/0 service partition 214 informs the power-metering module 206 regarding power consumption, for servicing requests on behalf of the client VM. When power consumption needs to be adjusted, the 1/0 service partition 214 serves as the throttling point by selectively reducing the service rate of the VMs that are the targets of resource reduction.

Applications 218 interact with the guest kernels 216 that in turn act as a bridge to the virtual environment of the system 200.

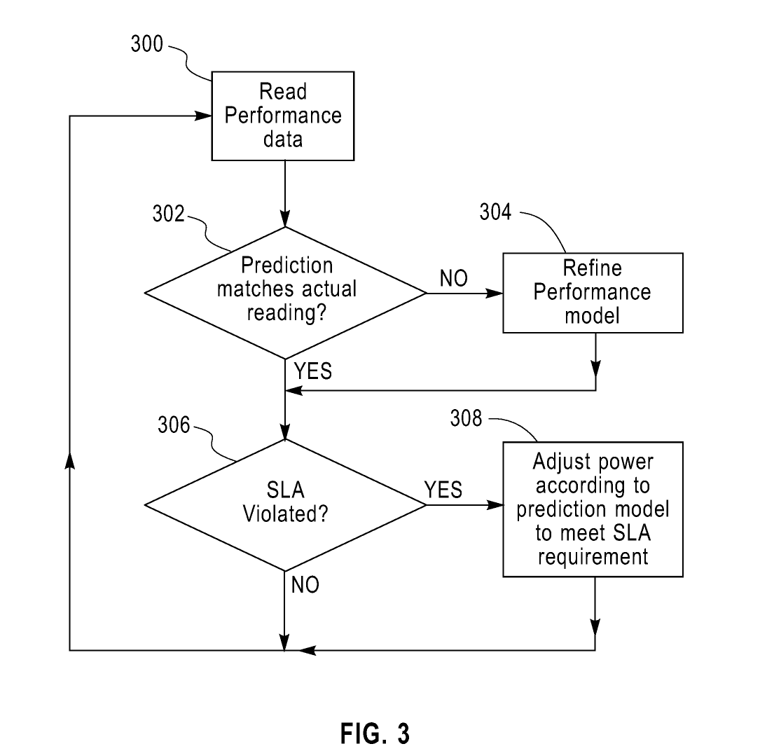

FIG. 3 is a flow diagram illustrating an exemplary operation of a performance monitor component 210 according to an embodiment of the invention. The performance monitor component 210 reads performance data (block 300) obtained via the hypervisor 204. The performance monitor verifies if the actual performance data matches the predicted performance data of the performance model (block 302). If the actual performance reading varies from the model prediction, the performance model is refined (block 304). The performance monitor component next checks if the SLA has been violated (block 306). If the SLA has been violated, the performance monitor component 210 adjusts the power according to the prediction model to meet the SLA requirement (block 308). The steps in the flow diagram are repeated in a continuous loop, by returning to block 300 to repeat the process of operation of the performance monitor 210.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing hypervisor based power management, the method comprising:
allocating resources to a plurality of partitions defined within a virtual machine (VM) environment;
monitoring performance of the plurality of partitions with respect to a service level agreement (SLA);
tracking power consumption in the plurality of partitions;
scaling power consumption rates of the plurality of partitions based on the allocated resources, wherein the power consumption rate of physical resources is scaled by adjusting resource allocations to each partition;
identifying partitions that are sources of excessive power consumption based on the SLA; and
adjusting the allocation of resources based on the power consumption of the plurality of partitions, the performance of the plurality of partitions, and the SLA.

2. The method of claim 1, further comprising monitoring performance by verifying if actual performance data matches predicted performance data based on a performance model; and
wherein if the actual performance reading varies from performance model, the performance model is refined.

3. The method of claim 1, further comprising tracking the power consumption in the plurality of partitions by direct measurement.

4. The method of claim 1, further comprising tracking the power consumption in the plurality of partitions by data extrapolation.

5. The method of claim 4, wherein the extrapolation is based on previously determined power performance data obtained during a calibration period.

6. The method of claim 1, wherein in the SLA specifies levels of service with respect to available resources.

7. The method of claim 1, wherein the SLA specifies acceptable tradeoffs between power consumption and performance.

8. The method of claim 1, wherein the adjusting the allocation of resources comprises at least one of the following:
adjusting a processor's speed;
adjusting a processor's share;
adjusting a partition's input/output (I/O) share; and
selectively changing the service rate of VMs that are the targets of resource adjustment.

9. A system for hypervisor based power management in a virtualized environment, the system comprising:
a first layer of hardware resources;
a second layer including a hypervisor that virtualizes the hardware resources and provides an upper third layer with the appearance of multiple independent virtual machine partitions;
a performance monitor in communication with the hypervisor, the performance monitor configured to observe the performance of the virtual machine partitions;
a policy manager in communication with the hypervisor, the policy manager configured to allocate resources to the virtual machine partitions;
a power metering component and a power control component configured within the hypervisor, the power metering component configured to track power consumption in the virtual machine partitions, and the power control component configured to scale power consumption rates of the virtual machine partitions based on the allocated resources;
an I/O service partition in communication with the hypervisor;
wherein the power metering component identifies virtual machine partitions that are sources of excessive power consumption based on a service level agreement (SLA);
wherein the performance monitor compares the performance of the virtual machine partitions to the SLA;
wherein the policy manager allocates resources based on the SLA; and
wherein the hypervisor adjusts input/output share of the virtual machines with the I/O service partition.

10. The system of claim 9, wherein the tracking of power consumption by the power meter component is carried out by direct measurement.

11. The system of claim 9, wherein the tracking of power consumption by the power meter component is carried out by data extrapolation.

12. The system of claim 9, wherein the extrapolation is based on previously determined power performance data obtained during a calibration period.

13. The system of claim 9, wherein in the SLA specifies levels of service with respect to available resources.

14. The system of claim 9, wherein the SLA specifies acceptable tradeoffs between power consumption and performance.

15. The system of claim 14, wherein the tradeoffs between power consumption and performance comprises at least one of the following:
adjusting a processor's speed;
adjusting a processor's share;
adjusting a partition's input/output (I/O) share; and
selectively changing the service rate of VMs that are the targets of resource adjustment.
